(19) United States
(12) Patent Application Publication
(10) Pub. No.: US 2014/0365319 A1
(43) Pub. Date: Dec. 11, 2014

(54) MECHANISM FOR MANAGING ONLINE CONTENT ON TOUCHSCREEN DEVICES IN THE FLOW OF AN ONLINE PUBLICATION

(71) Applicant: Google Inc., Mountain View, CA (US)

(72) Inventors: Allen Huang, Mountain View, CA (US); Lynn Nguyen, Milpitas, CA (US); Siavash Sedigh Nejad, San Francisco, CA (US); Michael Ying, Burlingame, CA (US)

(21) Appl. No.: 13/914,229

(22) Filed: Jun. 10, 2013

(51) Int. Cl. G06F 3/0484; G06Q 30/02

(52) U.S. Cl. CPC G06F 3/0484; G06Q 30/0277
USPC 705/14.73; 715/738

(57) ABSTRACT

An online content server includes a memory device for storing data and a processor in communication with the memory device. The processor is programmed to store dynamic online content and to receive a content request for displaying dynamic online content on a mobile computing device. The content request is initiated at least in part by a publication request. The processor is programmed to determine that the content request is associated with one of the dynamic online content and to deliver the dynamic online content with an overlay layer to the mobile computing device for display to a user. The overlay layer is positioned at least partially over the dynamic online content. The overlay layer allows the user to activate the dynamic online content or to navigate to a navigated publication item representing one of the first publication item or a second publication item.

### BACKGROUND

This description relates to displaying dynamic online content with an overlay layer on mobile computing devices prior to displaying a requested online publication, and, more particularly, to a network-based method and system for activating and/or deactivating online content displayed on a touchscreen device in the flow of an online publication.

Some known online content presented on mobile computing devices are interactive. Some known interactive online content presented on mobile computing devices include interactive advertisements. Many of such interactive online content are served prior to or in between serving online publications.

In some cases users may wish to interact with online content while in other cases, users may wish to dismiss the online content and navigate to an online publication. When online content is interactive, it may be difficult to distinguish between users seeking to interact with the online content and those who inadvertently interact with the online content while attempting to navigate to the online publication.

Some interactive online content and online publications can receive similar user-input interactions including haptic inputs. An input, such as a gesture on a touchscreen, may inadvertently be received by an interactive online content instead of by an online publication or vice versa. Therefore, a user viewing and interacting with online publications may accidentally interact with interactive online content or vice versa.

### BRIEF DESCRIPTION OF EXAMPLE EMBODIMENTS

In one aspect, a computer-implemented method for serving dynamic online content having an overlay layer on a mobile computing device is provided. The method is implemented by an online content server coupled to a memory device. The method includes storing within the memory device a plurality of dynamic online content and also includes receiving, at the online content server, a content request for displaying dynamic online content on a mobile computing device. The content request is initiated at least in part by a publication request being submitted by the mobile computing device for displaying a first publication item on the mobile computing device. The method also includes determining, at the online content server, that the content request is associated with one of the plurality of dynamic online content and additionally includes delivering the dynamic online content with an overlay layer to the mobile computing device for display to a user. The overlay layer is positioned at least partially over the dynamic online content on the mobile computing device. The overlay layer allows the user to provide haptic input to activate the dynamic online content or to navigate to a navigated publication item representing one of the first publication item or a second publication item.

In another aspect, an online content server for serving dynamic online content along with an overlay layer on a mobile computing device is provided. The online content server includes a memory device for storing data and a processor in communication with the memory device. The processor is programmed to store, within the memory device, a plurality of dynamic online content and to receive a content request for displaying dynamic online content on a mobile computing device. The content request is initiated at least in part by a publication request being submitted by the mobile computing device for displaying a first publication item on the mobile computing device. The processor is also programmed to determine that the content request is associated with one of the plurality of dynamic online content and to deliver the dynamic online content with an overlay layer to the mobile computing device for display to a user. The overlay layer is positioned at least partially over the dynamic online content on the mobile computing device. The overlay layer allows the user to provide haptic input to activate the dynamic online content or to navigate to a navigated publication item representing one of the first publication item or a second publication item.

In another aspect, a computer-readable storage device having processor-executable instructions embodied thereon, for serving dynamic online content in combination with an overlay layer on a mobile computing device is provided. When executed by a computing device, the processor-executable instructions cause the computing device to store, within the memory device, a plurality of dynamic online content. The processor-executable instructions also cause the computing device to receive a content request for displaying dynamic online content on a mobile computing device. The content request is initiated at least in part by a publication request being submitted by the mobile computing device for displaying a first publication item on the mobile computing device. The processor-executable instructions further cause the computing device to determine that the content request is associated with one of the plurality of dynamic online content and to deliver the dynamic online content with an overlay layer to the mobile computing device for display to a user. The overlay layer is positioned at least partially over the dynamic online content on the mobile computing device. The overlay layer allows the user to provide haptic input to activate the dynamic online content or to navigate to a navigated publication item representing one of the first publication item or a second publication item.

In another aspect, a system for dynamic online content along with an overlay layer on a mobile computing device is provided. The system includes means for storing a plurality of dynamic online content. The system also includes means for receiving a content request for displaying dynamic online content on a mobile computing device. The content request is initiated at least in part by a publication request being submitted by the mobile computing device for displaying a first publication item on the mobile computing device. The system further includes means for determining that the content request is associated with one of the plurality of dynamic online content and for delivering the dynamic online content with an overlay layer to the mobile computing device for display to a user. The overlay layer is positioned at least partially over the dynamic online content on the mobile computing device. The overlay layer allows the user to provide haptic input to activate the dynamic online content or to navigate to a navigated publication item representing one of the first publication item or a second publication item.

In another aspect, the system described above is provided, wherein the system further includes means for storing a plurality of dynamic online advertisements.

In another aspect, the system described above is provided, wherein the system further includes means for delivering a tap overlay layer wherein the tap overlay layer allows user-initiated haptic taps to interact with the dynamic online content and user-initiated haptic swipes to navigate to the navigated publication item.

In another aspect, the system described above is provided, wherein the system further includes means for delivering an activation overlay layer wherein the activation overlay layer requires a user-initiated haptic tap on at least one portion of the activation overlay layer for the user to interact with the dynamic online content.

In another aspect, the system described above is provided, wherein the system further includes means for delivering a user indication that dynamic online content is being delivered wherein the user indication is at least one of a graphical indication, a sonic indication, and a haptic indication.

In another aspect, the system described above is provided, wherein the system further includes means for determining that the dynamic online content should be served without an overlay layer based upon a request by a publisher of the first publication item.

In another aspect, the system described above is provided, wherein the system further includes means for delivering an activation indicator displayed to the user indicating whether the overlay layer is enabled or disabled.

The features, functions, and advantages described herein may be achieved independently in various embodiments of the present disclosure or may be combined in yet other embodiments, further details of which may be seen with reference to the following description and drawings.

### BRIEF DESCRIPTION OF THE DRAWINGS

FIG. 1 is a diagram depicting an example advertising environment;

FIG. 2 is a block diagram of a computing device, used for delivering dynamic online content having an overlay layer to a mobile computing device, as shown in the advertising environment of FIG. 1;

FIG. 3 is an example mobile computing device displaying content, including publication content, which may be subsequently served with dynamic online content having an overlay layer using the computing device of FIG. 2 in the advertising environment shown in FIG. 1;

FIG. 4 is an example mobile computing device displaying dynamic online content using the computing device of FIG. 2 in the advertising environment shown in FIG. 1;

FIG. 5 is an example mobile computing device displaying dynamic online content along with an overlay layer, specifically an activation overlay layer, using the computing device of FIG. 2 in the advertising environment shown in FIG. 1;

FIG. 5A is an example mobile computing device displaying dynamic online content along with an alternative overlay layer, specifically a tap overlay layer, using the computing device of FIG. 2 in the advertising environment shown in FIG. 1;

FIG. 6 is a lateral view of an example mobile computing device displaying dynamic online content with an overlay layer, specifically an activation overlay layer, using the computing device of FIG. 2 in the advertising environment shown in FIG. 1;

FIG. 6A is a lateral view of an example mobile computing device displaying dynamic online content with an overlay layer, specifically a tap overlay layer, using the computing device of FIG. 2 in the advertising environment shown in FIG. 1;

FIG. 7 is a further example mobile computing device displaying dynamic online content with an overlay layer as shown in FIG. 5B wherein a user elects to interact with the dynamic online content, using the computing device of FIG. 2 in the advertising environment shown in FIG. 1;

FIG. 7A is another example mobile computing device displaying dynamic online content with an overlay layer as shown in FIG. 5B wherein a user elects to dismiss the dynamic online content and navigate to a publication item, using the computing device of FIG. 2 in the advertising environment shown in FIG. 1;

FIG. 8 is an example method for automatically displaying dynamic online content on a mobile computing device as shown in the advertising environment of FIG. 1; and

FIG. 9 is a diagram of components of one or more example computing devices that may be used in the environment shown in FIG. 1.

Although specific features of various embodiments may be shown in some drawings and not in others, this is for convenience only. Any feature of any drawing may be referenced and/or claimed in combination with any feature of any other drawing.

### DETAILED DESCRIPTION OF THE DISCLOSURE

The following detailed description of implementations refers to the accompanying drawings. The same reference numbers in different drawings may identify the same or similar elements. Also, the following detailed description does not limit the claims.

As used herein, an element or step recited in the singular and proceeded with the word “a” or “an” should be understood as not excluding plural elements or steps, unless such exclusion is explicitly recited. Furthermore, references to “one embodiment” of the subject matter disclosed herein are not intended to be interpreted as excluding the existence of additional embodiments that also incorporate the recited features.

This subject matter described herein relates generally to delivering dynamic online content and a publication item to a mobile computing device for display to a potential consumer (“user”), wherein the dynamic online content includes an overlay layer positioned at least partially over the dynamic online content.

As used herein, “dynamic online content” refers to online content which may be served by a content management server. Dynamic online content may include, without limitation, an online advertisement, text, animation, video, or any other content which may be served and displayed using a mobile computing device. In the example embodiment, the dynamic online content may be an advertisement such as a rich media advertisement.

Specifically, the methods and systems described herein enable the storing and delivering of dynamic online content presented to a user viewing the online content on a mobile computing device, where the dynamic online content is presented with an overlay layer.

Initially, a plurality of dynamic online content is stored in the memory device of an online content server. In some embodiments, the plurality of dynamic online content includes a plurality of dynamic online advertisements. The online content server next receives a content request for displaying dynamic online content on a mobile computing device. The content request is at least partially initiated by a publication request submitted by the mobile computing device. The publication request represents a request to display a first publication item on the mobile computing device. As used herein, a “publication request” represents a request to receive an online publication, such as an online periodical or electronic book. The publication request at least partially initiates a content request. The content request represents a request to receive dynamic online content, such as an online advertisement.

The online content server next determines that the content request is associated with one of the plurality of dynamic content. In some embodiments, this determination includes determining that the dynamic online content should be served without an overlay layer based upon a request by a publisher of the first publication item.

Upon determining that the content request is associated with one of the plurality of dynamic content, the online content server delivers dynamic online content to the mobile computing device.

The dynamic online content is delivered and displayed on the mobile computing device prior to the display of the requested publication. The dynamic online content is delivered with an overlay layer. The overlay layer is configured to receive user input for activating the dynamic online content or for navigating to a navigated publication item. In some embodiments, the overlay layer is a tap overlay layer. A tap overlay layer allows user-initiated haptic taps to interact with the dynamic online content and user-initiated haptic swipes to navigate to a navigated publication item. In other embodiments, the overlay layer is an activation layer. An activation overlay layer requires a user-initiated haptic tap on at least one portion of the activation overlay layer for the user to interact with the dynamic online content. In some embodiments, the dynamic online content is delivered with a user indication that dynamic online content is being delivered. The user indication may include a graphical indication, a sonic indication, and a haptic indication. In other embodiments, delivering the dynamic online content with an overlay layer to the mobile computing device for display to a user further comprises delivering an activation indicator displayed to the user indicating whether the overlay layer is enabled or disabled.

In other words, the methods and systems described herein facilitate storing a plurality of dynamic online content, receiving a content request for displaying dynamic online content on a mobile computing device, determining that the content request is associated with one of the plurality of dynamic online content, and delivering the dynamic online content with an overlay layer to the mobile computing device for display to a user wherein the overlay layer is configured to activate or deactivate the dynamic online content.

The methods and systems described herein may be implemented using computer programming or engineering techniques including computer software, firmware, hardware or any combination or subset thereof, wherein the technical effects may be achieved by performing one of the following steps: (a) storing a plurality of dynamic online content within the memory device; (b) receiving a content request for displaying dynamic online content on a mobile computing device, wherein the content request is initiated at least in part by a publication request being submitted by the mobile computing device for displaying a first publication item on the mobile computing device; (c) determining that the content request is associated with one of the plurality of dynamic online content; (d) delivering the dynamic online content with an overlay layer to the mobile computing device for display to a user wherein the overlay layer is positioned at least partially over the dynamic online content on the mobile computing device and wherein the overlay layer allows the user to provide haptic input to activate the dynamic online content or navigate to a navigated publication item representing one of the first publication item or a second publication item; (e) storing a plurality of dynamic online advertisements; (f) delivering a tap overlay layer wherein the tap overlay layer allows user-initiated haptic taps to interact with the dynamic online content and user-initiated haptic swipes to navigate to the navigated publication item; (g) delivering an activation overlay layer wherein the activation overlay layer requires a user-initiated haptic tap on at least one portion of the activation overlay layer for the user to interact with the dynamic online content; (h) delivering a user indication that dynamic online content is being delivered wherein the user indication is at least one of a graphical indication, a sonic indication, and a haptic indication; (i) determining that the dynamic online content should be served without an overlay layer based upon a request by a publisher of the first publication item; (j) delivering an activation indicator displayed to the user indicating whether the overlay layer is enabled or disabled.

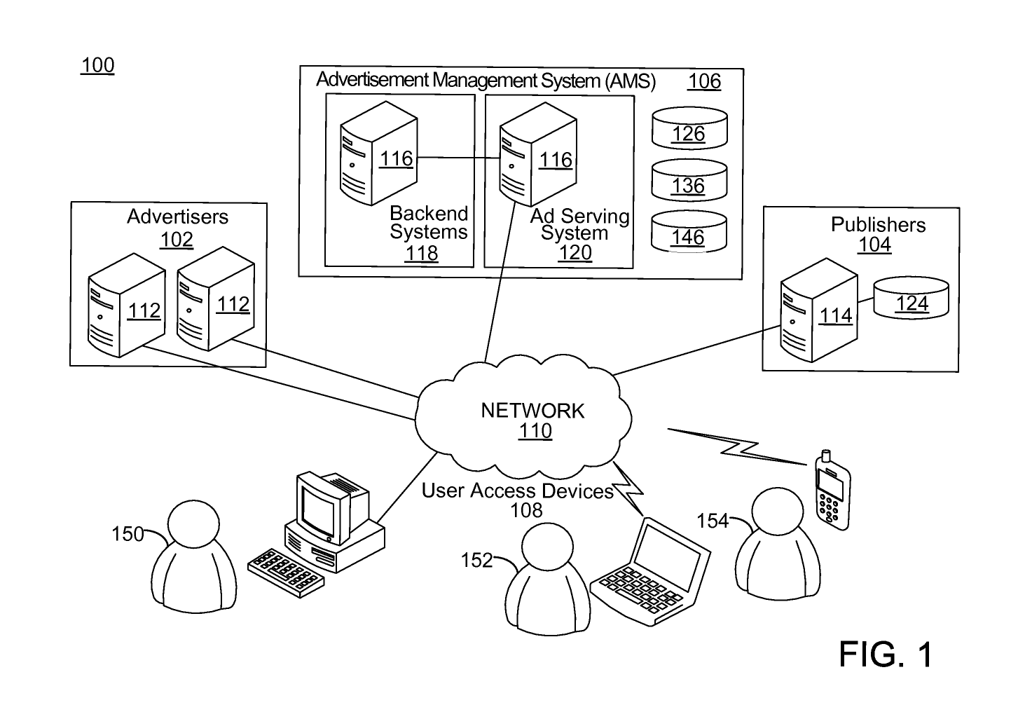

FIG. 1 is a diagram depicting an example online content environment 100. In the example embodiment, online content environment 100 may be used in the context of serving online advertisements to a user in combination with online publications. With reference to FIG. 1, example online content environment 100 may include one or more advertisers 102, one or more publishers 104, an advertisement management system (AMS) 106, and one or more user access devices 108, which may be coupled to a network 110. User access devices are used by users 150, 152, and 154. Each of the elements 102, 104, 106, 108 and 110 in FIG. 1 may be implemented or associated with hardware components, software components, or firmware components or any combination of such components. The elements 102, 104, 106, 108 and 110 can, for example, be implemented or associated with general purpose servers, software processes and engines, and/or various embedded systems. The elements 102, 104, 106 and 110 may serve, for example, as an advertisement distribution network. While reference is made to distributing advertisements, the environment 100 can be suitable for distributing other forms of content including other forms of sponsored content. AMS 106 may also be referred to as a content management system.

The advertisers 102 may include any entities that are associated with advertisements (“ads”). An advertisement or an “ad” refers to any form of communication in which one or more products, services, ideas, messages, people, organizations or other items are identified and promoted (or otherwise communicated). Ads are not limited to commercial promotions or other communications. An ad may be a public service announcement or any other type of notice, such as a public notice published in printed or electronic press or a broadcast. An ad may be referred to as sponsored content.

Ads may be communicated via various mediums and in various forms. In some examples, ads may be communicated through an interactive medium, such as the Internet, and may include graphical ads (e.g., banner ads), textual ads, image ads, audio ads, video ads, ads combining one of more of any of such components, or any form of electronically delivered advertisement. Ads may include embedded information, such as embedded media, links, meta-information, and/or machine executable instructions. Ads could also be communicated through RSS (Really Simple Syndication) feeds, radio channels, television channels, print media, and other media.

The term “ad” can refer to both a single “creative” and an “ad group.” A creative refers to any entity that represents one ad impression. An ad impression refers to any form of presentation of an ad such that it is viewable/receivable by a user. In some examples, an ad impression may occur when an ad is displayed on a display device of a user access device. An ad group refers, for example, to an entity that represents a group of creatives that share a common characteristic, such as having the same ad selection and recommendation criteria. Ad groups can be used to create an ad campaign.

The advertisers 102 may provide (or be otherwise associated with) products and/or services related to ads. The advertisers 102 may include or be associated with, for example, retailers, wholesalers, warehouses, manufacturers, distributors, health care providers, educational establishments, financial establishments, technology providers, energy providers, utility providers, or any other product or service providers or distributors.

The advertisers 102 may directly or indirectly generate, maintain, and/or track ads, which may be related to products or services offered by or otherwise associated with the advertisers. The advertisers 102 may include or maintain one or more data processing systems 112, such as servers or embedded systems, coupled to the network 110. The advertisers 102 may include or maintain one or more processes that run on one or more data processing systems.

The publishers 104 may include any entities that generate, maintain, provide, present and/or otherwise process content in the environment 100. “Publishers,” in particular, include authors of content, wherein authors may be individual persons, or, in the case of works made for hire, the proprietor(s) who hired the individual(s) responsible for creating the online content. The term “content” refers to various types of web-based, software application-based and/or otherwise presented information, including articles, discussion threads, reports, analyses, financial statements, music, video, graphics, search results, web page listings, information feeds (e.g., RSS feeds), television broadcasts, radio broadcasts, printed publications, or any other form of information that may be presented to a user using a computing device such as one of user access devices 108.

In some implementations, the publishers 104 may include content providers with an Internet presence, such as online publication and news providers (e.g., online newspapers, online magazines, television websites, etc.), online service providers (e.g., financial service providers, health service providers, etc.), and the like. The publishers 104 can include software application providers, television broadcasters, radio broadcasters, satellite broadcasters, and other content providers. One or more of the publishers 104 may represent a content network that is associated with the AMS 106.

The publishers 104 may receive requests from the user access devices 108 (or other elements in the environment 100) and provide or present content to the requesting devices. The publishers may provide or present content via various mediums and in various forms, including web based and non-web based mediums and forms. The publishers 104 may generate and/or maintain such content and/or retrieve the content from other network resources.

In addition to content, the publishers 104 may be configured to integrate or combine retrieved content with additional sets of content, for example ads, that are related or relevant to the retrieved content for display to users 150, 152, and 154. As discussed further below, these relevant ads may be provided from the AMS 106 and may be combined with content for display to users 150, 152, and 154. In some examples, the publishers 104 may retrieve content for display on a particular user access device 108 and then forward the content to the user access device 108 along with code that causes one or more ads from the AMS 106 to be displayed to the user 150, 152, or 154. In other examples, the publishers 104 may retrieve content, retrieve one or more relevant ads (e.g., from the AMS 106 or the advertisers 102), and then integrate the ads and the article to form a content page for display to the user 150, 152, or 154.

As noted above, one or more of the publishers 104 may represent a content network. In such an implementation, the advertisers 102 may be able to present ads to users through this content network.

The publishers 104 may include or maintain one or more data processing systems 114, such as servers or embedded systems, coupled to the network 110. They may include or maintain one or more processes that run on data processing systems. In some examples, the publishers 104 may include one or more content repositories 124 for storing content and other information.

The AMS 106 manages ads and provides various services to the advertisers 102, the publishers 104, and the user access devices 108. The AMS 106 may store ads in an ad repository 126 and facilitate the distribution or selective provision and recommendation of ads through the environment 100 to the user access devices 108. In some configurations, the AMS 106 may include or access functionality associated with managing online content and/or online advertisements, particularly functionality associated with serving online content and/or online advertisements to mobile computing devices.

The AMS 106 may include one or more data processing systems 116, such as servers or embedded systems, coupled to the network 110. It can also include one or more processes, such as server processes. In some examples, the AMS 106 may include an ad serving system 120 and one or more backend processing systems 118. The ad serving system 120 may include one or more data processing systems 116 and may perform functionality associated with delivering ads to publishers or user access devices 108. The backend processing systems 118 may include one or more data processing systems 116 and may perform functionality associated with identifying relevant ads to deliver, processing various rules, performing filtering processes, generating reports, maintaining accounts and usage information, and other backend system processing. The AMS 106 can use the backend processing systems 118 and the ad serving system 120 to selectively recommend and provide relevant ads from the advertisers 102 through the publishers 104 to the user access devices 108.

The AMS 106 may include or access one or more crawling, indexing and searching modules (not shown). These modules may browse accessible resources (e.g., the World Wide Web, publisher content, data feeds, etc.) to identify, index and store information. The modules may browse information and create copies of the browsed information for subsequent processing. The modules may also check links, validate code, harvest information, and/or perform other maintenance or other tasks.

Searching modules may search information from various resources, such as the World Wide Web, publisher content, intranets, newsgroups, databases, and/or directories. The search modules may employ one or more known search or other processes to search data. In some implementations, the search modules may index crawled content and/or content received from data feeds to build one or more search indices. The search indices may be used to facilitate rapid retrieval of information relevant to a search query.

The AMS 106 may include one or more interface or frontend modules for providing the various features to advertisers, publishers, and user access devices. For example, the AMS 106 may provide one or more publisher front-end interfaces (PFEs) for allowing publishers to interact with the AMS 106. The AMS 106 may also provide one or more advertiser front-end interfaces (AFEs) for allowing advertisers to interact with the AMS 106. In some examples, the front-end interfaces may be configured as web applications that provide users with network access to features available in the AMS 106.

The AMS 106 provides various advertising management features to the advertisers 102. The AMS 106 advertising features may allow users to set up user accounts, set account preferences, create ads, select keywords for ads, create campaigns or initiatives for multiple products or businesses, view reports associated with accounts, analyze costs and return on investment, selectively identify customers in different regions, selectively recommend and provide ads to particular publishers, analyze financial information, analyze ad performance, estimate ad traffic, access keyword tools, add graphics and animations to ads, etc.

The AMS 106 may allow the advertisers 102 to create ads and input keywords for which those ads will appear. In some examples, the AMS 106 may provide ads to user access devices or publishers when keywords associated with those ads are included in a user request or requested content. The AMS 106 may also allow the advertisers 102 to set bids for ads. A bid may represent the maximum amount an advertiser is willing to pay for each ad impression, user click-through of an ad or other interaction with an ad. A click-through can include any action a user takes to select an ad. The advertisers 102 may also choose a currency and monthly budget.

The AMS 106 may also allow the advertisers 102 to view information about ad impressions, which may be maintained by the AMS 106. The AMS 106 may be configured to determine and maintain the number of ad impressions relative to a particular website or keyword. The AMS 106 may also determine and maintain the number of click-throughs for an ad as well as the ratio of click-throughs to impressions.

The AMS 106 may also allow the advertisers 102 to select and/or create conversion types for ads. A “conversion” may occur when a user consummates a transaction related to a given ad. A conversion could be defined to occur when a user clicks on an ad, is referred to the advertiser's web page, and consummates a purchase there before leaving that web page. In another example, a conversion could be defined as the display of an ad to a user and a corresponding purchase on the advertiser's web page within a predetermined time (e.g., seven days). The AMS 106 may store conversion data and other information in a conversion data repository 136.

The AMS 106 may allow the advertisers 102 to input description information associated with ads. This information could be used to assist the publishers 104 in determining ads to publish. The advertisers 102 may additionally input a cost/value associated with selected conversion types, such as a five dollar credit to the publishers 104 for each product or service purchased.

The AMS 106 may provide various features to the publishers 104. The AMS 106 may deliver ads (associated with the advertisers 102) to the user access devices 108 when users access content from the publishers 104. The AMS 106 can be configured to deliver ads that are relevant to publisher sites, site content, and publisher audiences.

In some examples, the AMS 106 may crawl content provided by the publishers 104 and deliver ads that are relevant to publisher sites, site content and publisher audiences based on the crawled content. The AMS 106 may also selectively recommend and/or provide ads based on user information and behavior, such as particular search queries performed on a search engine website, or a designation of an ad for subsequent review, as described herein, etc. The AMS 106 may store user-related information in a general database 146. In some examples, the AMS 106 can add search services to a publisher site and deliver ads configured to provide appropriate and relevant content relative to search results generated by requests from visitors of the publisher site. A combination of these and other approaches can be used to deliver relevant ads.

The AMS 106 may allow the publishers 104 to search and select specific products and services as well as associated ads to be displayed with content provided by the publishers 104. For example, the publishers 104 may search through ads in the ad repository 126 and select certain ads for display with their content.

The AMS 106 may be configured to selectively recommend and provide ads created by the advertisers 102 to the user access devices 108 directly or through the publishers 104. The AMS 106 may selectively recommend and provide ads to a particular publisher 104 (as described in further detail herein) or a requesting user access device 108 when a user requests search results or loads content from the publisher 104.

In some implementations, the AMS 106 may manage and process financial transactions among and between elements in the environment 100. For example, the AMS 106 may credit accounts associated with the publishers 104 and debit accounts of the advertisers 102. These and other transactions may be based on conversion data, impressions information and/or click-through rates received and maintained by the AMS 106.

“Computing devices”, for example user access devices 108, may include any devices capable of receiving information from the network 110. The user access devices 108 could include general computing components and/or embedded systems optimized with specific components for performing specific tasks. Examples of user access devices include personal computers (e.g., desktop computers), mobile computing devices, cell phones, smart phones, head-mounted computing devices, media players/recorders, music players, game consoles, media centers, media players, electronic tablets, personal digital assistants (PDAs), television systems, audio systems, radio systems, removable storage devices, navigation systems, set top boxes, other electronic devices and the like. The user access devices 108 can also include various other elements, such as processes running on various machines.

The network 110 may include any element or system that facilitates communications among and between various network nodes, such as elements 108, 112, 114 and 116. The network 110 may include one or more telecommunications networks, such as computer networks, telephone or other communications networks, the Internet, etc. The network 110 may include a shared, public, or private data network encompassing a wide area (e.g., WAN) or local area (e.g., LAN). In some implementations, the network 110 may facilitate data exchange by way of packet switching using the Internet Protocol (IP). The network 110 may facilitate wired and/or wireless connectivity and communication.

For purposes of explanation only, certain aspects of this disclosure are described with reference to the discrete elements illustrated in FIG. 1. The number, identity and arrangement of elements in the environment 100 are not limited to what is shown. For example, the environment 100 can include any number of geographically-dispersed advertisers 102, publishers 104 and/or user access devices 108, which may be discrete, integrated modules or distributed systems. Similarly, the environment 100 is not limited to a single AMS 106 and may include any number of integrated or distributed AMS systems or elements.

Furthermore, additional and/or different elements not shown may be contained in or coupled to the elements shown in FIG. 1, and/or certain illustrated elements may be absent. In some examples, the functions provided by the illustrated elements could be performed by less than the illustrated number of components or even by a single element. The illustrated elements could be implemented as individual processes running on separate machines or a single process running on a single machine.

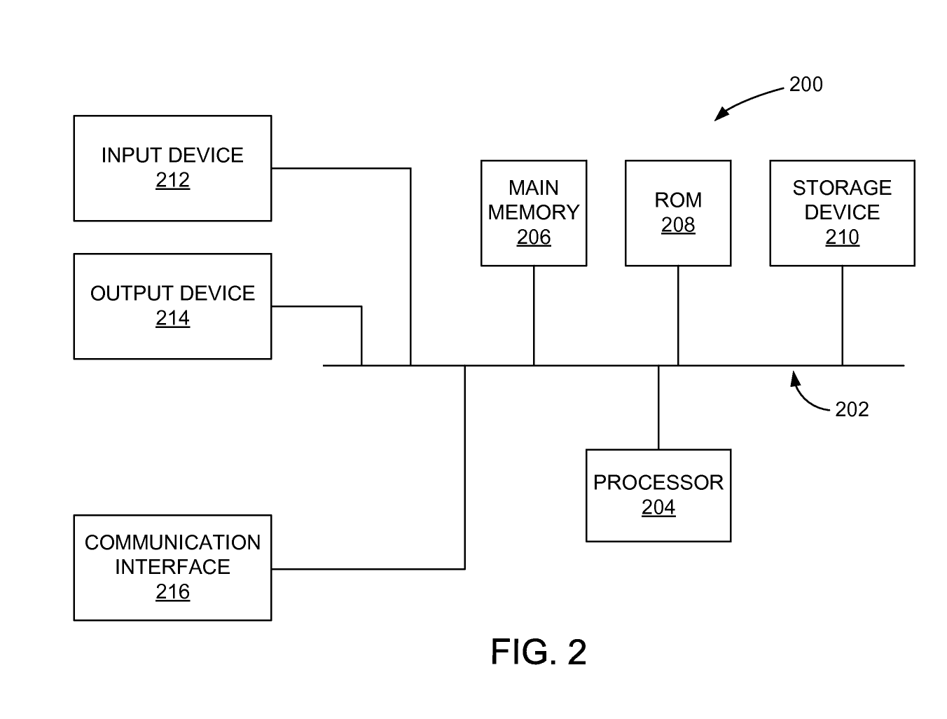

FIG. 2 is a block diagram of a computing device 200, used for delivering dynamic online content along with an overlay layer to another computing device such as a mobile computing device, as shown in the advertising environment 100 (shown in FIG. 1).

FIG. 2 shows an example of a generic computing device 200 intended to represent various forms of digital computers, such as laptops, desktops, workstations, personal digital assistants, servers, blade servers, mainframes, and other appropriate computers. Computing device 200 is also intended to represent various forms of mobile devices, such as personal digital assistants, cellular telephones, smart phones, and other similar computing devices. The components shown here, their connections and relationships, and their functions, are meant to be examples only, and are not meant to limit implementations of the subject matter described and/or claimed in this document.

In the example embodiment, computing device 200 could be user access device 108 or any of data processing devices 112, 114, or 116 (shown in FIG. 1). Computing device 200 may include a bus 202, a processor 204, a main memory 206, a read only memory (ROM) 208, a storage device 210, an input device 212, an output device 214, and a communication interface 216. Bus 202 may include a path that permits communication among the components of computing device 200.

Processor 204 may include any type of conventional processor, microprocessor, or processing logic that interprets and executes instructions. Processor 204 can process instructions for execution within the computing device 200, including instructions stored in the memory 206 or on the storage device 210 to display graphical information for a GUI on an external input/output device, such as display 214 coupled to a high speed interface. In other implementations, multiple processors and/or multiple buses may be used, as appropriate, along with multiple memories and types of memory. Also, multiple computing devices 200 may be connected, with each device providing portions of the necessary operations (e.g., as a server bank, a group of blade servers, or a multi-processor system).

Main memory 206 may include a random access memory (RAM) or another type of dynamic storage device that stores information and instructions for execution by processor 204. ROM 208 may include a conventional ROM device or another type of static storage device that stores static information and instructions for use by processor 204. Main memory 206 stores information within the computing device 200. In one implementation, main memory 206 is a volatile memory unit or units. In another implementation, main memory 206 is a non-volatile memory unit or units. Main memory 206 may also be another form of computer-readable medium, such as a magnetic or optical disk.

Storage device 210 may include a magnetic and/or optical recording medium and its corresponding drive. The storage device 210 is capable of providing mass storage for the computing device 200. In one implementation, the storage device 210 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as main memory 206, ROM 208, the storage device 210, or memory on processor 204.

The high speed controller manages bandwidth-intensive operations for the computing device 200, while the low speed controller manages lower bandwidth-intensive operations. Such allocation of functions is for purposes of example only. In one implementation, the high-speed controller is coupled to main memory 206, display 214 (e.g., through a graphics processor or accelerator), and to high-speed expansion ports, which may accept various expansion cards (not shown). In the implementation, low-speed controller is coupled to storage device 210 and low-speed expansion port. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

Input device 212 may include a conventional mechanism that permits computing device 200 to receive commands, instructions, or other inputs from a user 150, 152, or 154, including visual, audio, touch, button presses, stylus taps, etc. Additionally, input device may receive location information. Accordingly, input device 212 may include, for example, a camera, a microphone, one or more buttons, a touch screen, and/or a GPS receiver. Output device 214 may include a conventional mechanism that outputs information to the user, including a display (including a touch screen) and/or a speaker. Communication interface 216 may include any transceiver-like mechanism that enables computing device 200 to communicate with other devices and/or systems. For example, communication interface 216 may include mechanisms for communicating with another device or system via a network, such as network 110 (shown in FIG. 1).

As described herein, computing device 200 facilitates the presentation of content from one or more publishers, along with one or more sets of sponsored content, for example ads, to a user. Computing device 200 may perform these and other operations in response to processor 204 executing software instructions contained in a computer-readable medium, such as memory 206. A computer-readable medium may be defined as a physical or logical memory device and/or carrier wave. The software instructions may be read into memory 206 from another computer-readable medium, such as data storage device 210, or from another device via communication interface 216. The software instructions contained in memory 206 may cause processor 204 to perform processes described herein. Alternatively, hardwired circuitry may be used in place of or in combination with software instructions to implement processes consistent with the subject matter herein. Thus, implementations consistent with the principles of the subject matter disclosed herein are not limited to any specific combination of hardware circuitry and software.

The computing device 200 may be implemented in a number of different forms, as shown in the figure. For example, it may be implemented as a standard server, or multiple times in a group of such servers. It may also be implemented as part of a rack server system. In addition, it may be implemented in a personal computer such as a laptop computer. Each of such devices may contain one or more of computing device 200, and an entire system may be made up of multiple computing devices 200 communicating with each other.

The processor 204 can execute instructions within the computing device 200, including instructions stored in the main memory 206. The processor may be implemented as chips that include separate and multiple analog and digital processors. The processor may provide, for example, for coordination of the other components of the device 200, such as control of user interfaces, applications run by device 200, and wireless communication by device 200.

Computing device 200 includes a processor 204, main memory 206, ROM 208, an input device 212, an output device such as a display 214, a communication interface 216, among other components including, for example, a receiver and a transceiver. The device 200 may also be provided with a storage device 210, such as a microdrive or other device, to provide additional storage. Each of the components are interconnected using various buses, and several of the components may be mounted on a common motherboard or in other manners as appropriate.

Computing device 200 may communicate wirelessly through communication interface 216, which may include digital signal processing circuitry where necessary. Communication interface 216 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver. In addition, short-range communication may occur, such as using a Bluetooth, WiFi, or other such transceiver (not shown). In addition, a GPS (Global Positioning system) receiver module may provide additional navigation- and location-related wireless data to device 200, which may be used as appropriate by applications running on device 200.

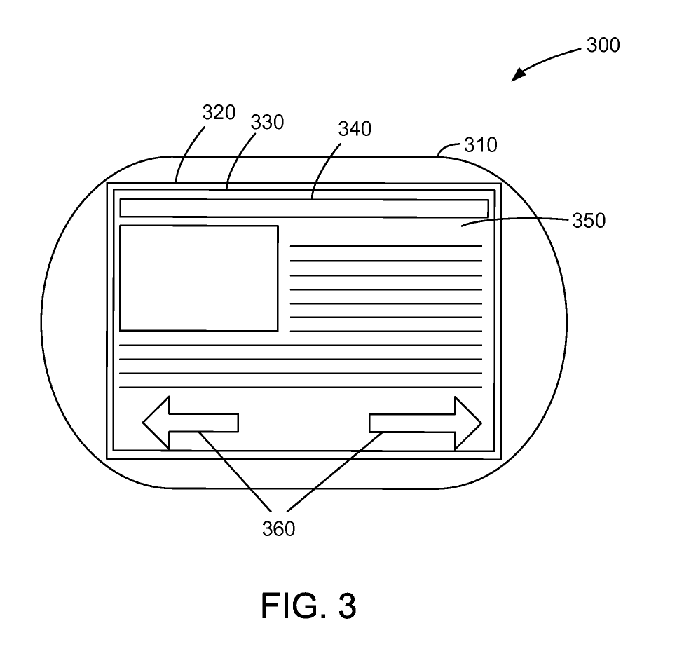

FIG. 3 is an example mobile computing device 310 displaying content, including online publication content 350, which may be subsequently served with dynamic online content along with an overlay layer using computing device 200 (shown in FIG. 2) in advertising environment 100 (shown in FIG. 1). In the example embodiment, mobile computing device 310 is a smart phone such as user access device 108 used by user 154 (shown in FIG. 1). In alternative embodiments, mobile computing device 310 may include, without limitation, a smart phone, a personal digital assistant, a computer tablet, a hybrid phone/computer tablet (“phablet”), or other similar mobile device capable of communicating to the web. In the example embodiment, mobile computing device 310 also includes a microphone and speakers (not shown) for telephonic communication, recording, and audio playback.

Mobile computing device 310 includes a mobile computing device display 320. Mobile computing device display 320 is a touchscreen display. Mobile computing device display 320 is configured to display visual information including, without limitation, text, graphics, animation, video, applications, games, and any other visual information which can be displayed on mobile computing device 310. Mobile computing device display 320 is also configured to receive haptic (e.g., tactile) input from a user such as user 154. Haptic input refers to input which can be provided by user 154 interacting with a device through tactile interaction. Mobile computing device 310 is further capable of transmitting haptic output or haptic feedback wherein user 154 senses output which may be detected through tactile interaction including, for example, vibration.

Mobile computing device display 320 displays information using mobile application 330. In the example embodiment, mobile application 330 is a web browser capable of displaying online publication content 350 received from an online publication resource 340. In other embodiments, mobile application 330 may be, without limitation, an electronic reader, a web application, a mobile web game, or any other application which is configured to display online publication content 350. Mobile application 330 may be stored in a memory device of mobile computing device 310 and run from a processor of mobile computing device 310. Mobile application 330 may be written in any program language suitable for development with mobile computing device 310.

Online publication resource 340 indicates the Internet or network resource which serves online publication content 350. In the example embodiment, online publication content 350 is a publication from an Internet news publisher. In alternative embodiments, online publication content 350 may be, without limitation, text, graphics, video, animation, games, or any other online publication content 350 which may be served using mobile application 330.

As used herein, “publication request” refers to a request initiated by mobile computing device 310 which requests data associated with an online publication to be delivered to mobile computing device 310. Such data is at least partially represented by online publication content 350. In some cases, additional content is delivered to mobile computing device 310 and not initially displayed.

Mobile application 330 also includes navigation elements 360. Navigation elements 360 allow user 154 to request additional online publication content 350 to be served on mobile application 330. In the example embodiment, navigation element 360 allows user 154 to navigate through a publication (i.e., to advance from one page to the next page or to return to a previous page in an electronic book or electronic periodical). In alternative embodiments, navigation elements 360 may allow user 154 to request any new online publication content 350 which may be served on mobile application 330. In the example embodiment, navigation elements 360 are arrows allowing user 154 to navigate within a web publication. In alternative embodiments, navigation elements 360 may include other icons or links allow user 154 to navigate to other online publication content 350. In some embodiments, navigation elements 360 may cause user 154 to navigate to online publication content 350 which requires opening a new mobile application 330. For example, user 154 may use a mobile application 330 wherein mobile application 330 is a web browser and select navigation element 360 to navigate to a video. In some instances, user 154 will cause a secondary mobile application 330 specifically designed to display videos in order to display the video. User 154 can additionally use other elements of mobile application 330 to navigate to additional online publication content 350. For example, user 154 may enter a new URL into online publication resource 340 and open new online publication content 350. In other examples (not shown), user 154 may enter information into a search bar on mobile application 330 to navigate to a search screen or to specific online publication content 350.

In the example embodiment, online publication content 350 represents all content displayed in mobile application 330. In alternative embodiments, online publication content 350 may represent a portion of content displayed in mobile application 330 while additional content is served from other resources including, without limitation, network resources, local resources, and resources of other computing devices. For example, mobile application 330 may be an electronic reader which serves text content from a book to user 154. Mobile application 330 may include text content along with online publication content 350.

In operation, user 154 uses mobile computing device 310, using mobile computing device display 320 to activate or open mobile application 330. User 154 views online publication content 350 and navigates to additional online publications using navigation elements 360 or by entering a new URL into online publication resource 340.

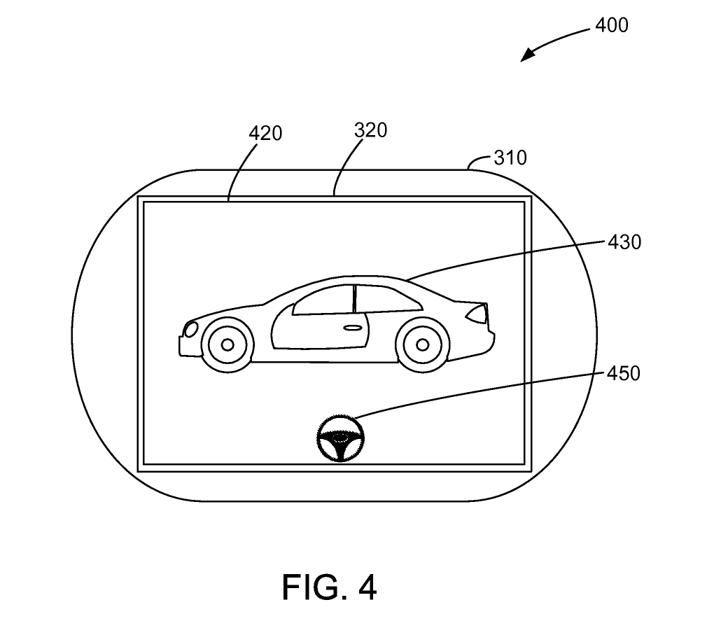

FIG. 4 is example mobile computing device 310 displaying dynamic online content using computing device 200 (shown in FIG. 2 in) advertising environment 100 (shown in FIG. 1). In example 400, mobile computing device 310 displays dynamic online content 420 in mobile application 330 on mobile computing device display 320. In the example embodiment, dynamic online content 420 is an advertisement for an automobile. Further, in the example embodiment, dynamic online content 420 is served to mobile computing device 310 after a user such as user 154 (shown in FIG. 1) requests an online publication using mobile application 330. In the example embodiment, although dynamic online content 420 is different from online publication content 350, both may be served using mobile application 330.

In the example embodiment, dynamic online content 420 is an interactive advertisement with graphic and animation features. In alternative embodiments, dynamic online content 420 may be, without limitation, an online advertisement, text, animation, video, or any other content which may be served and displayed using mobile application 330.

Dynamic online content 420 includes online creative elements 430. Online creative elements 430 represents all creative elements included in dynamic online content 420. Online creative elements 430 may be graphical, animation, textual, sonic, haptic, or any other category of creative capable of being displayed on mobile application 330. Online creative elements 430 may additionally be a combination of multiple types of elements. In the example embodiment, online creative element 430 is a car which is animated and produces the sound of an engine.

Dynamic online content 420 also includes user interaction elements 450. User interaction elements 450 represent any elements of dynamic online content 420 which may allow user 154 to interact. In the example embodiment, user interaction element 450 is a steering wheel. If user 154 provides haptic input (i.e., uses mobile computing device display 320 to touch and swipe) user interaction element 450, dynamic online content 420 and, more specifically, online creative elements 430 will respond. For example, if user 154 provides haptic input to turn the steering wheel in user interaction element 450, the car representing online creative elements 430 will turn in the same direction as the steering wheel. As used herein, “dismiss function,” refers to an approach used in displaying dynamic online content 420 which allows input received by user 154 to result in removal of dynamic online content 420. In the example embodiment, dynamic online content 420 may be configured to receive haptic input which will cause dynamic online content 420 to be removed. In some embodiments, graphical or textual indicators may be displayed on dynamic online content 420 to indicate that the dismiss function is available.

In operation, dynamic online content 420 is served to mobile computing device 310 when user 154 navigates from web content such as online publication content 350 (shown in FIG. 3) to further web content. User 154 may navigate using navigation elements 360, entering a new online publication resource 340 (both shown in FIG. 3), entering a search, or clicking on a link within online publication content 350 or elsewhere. Dynamic online content 420 is served by ad serving system 120 (shown in FIG. 1) using a process described in detail below.

In at least some examples, dynamic online content 420 may be capable of recording user interactions with user interaction elements 450. Such information may be of interest to the publisher or creator of dynamic online content 420 as it may indicate the user response to particular dynamic online content 420. Once dynamic online content 420 is served to mobile computing device 310, user 154 may elect to view dynamic online content 420, interact with dynamic online content 420 using user interaction elements 450, or dismiss dynamic online content 420 and navigate to a requested publication.

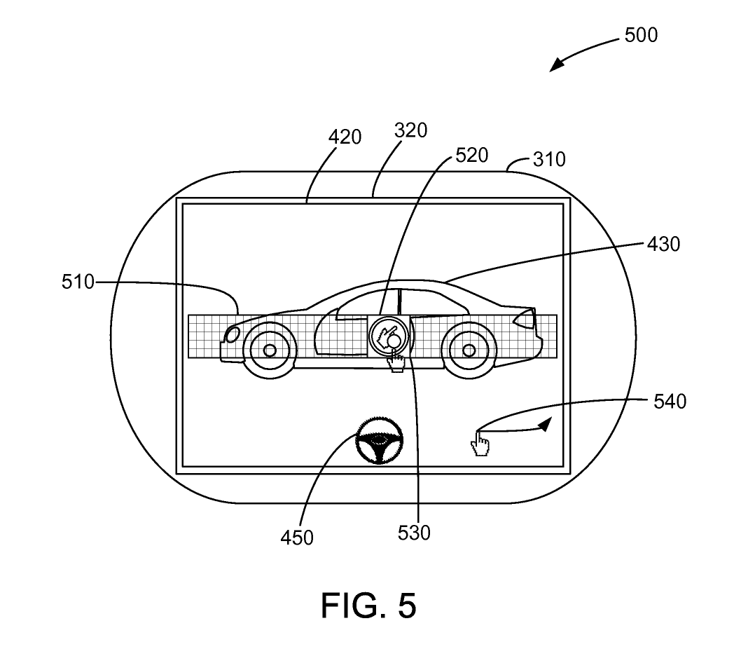

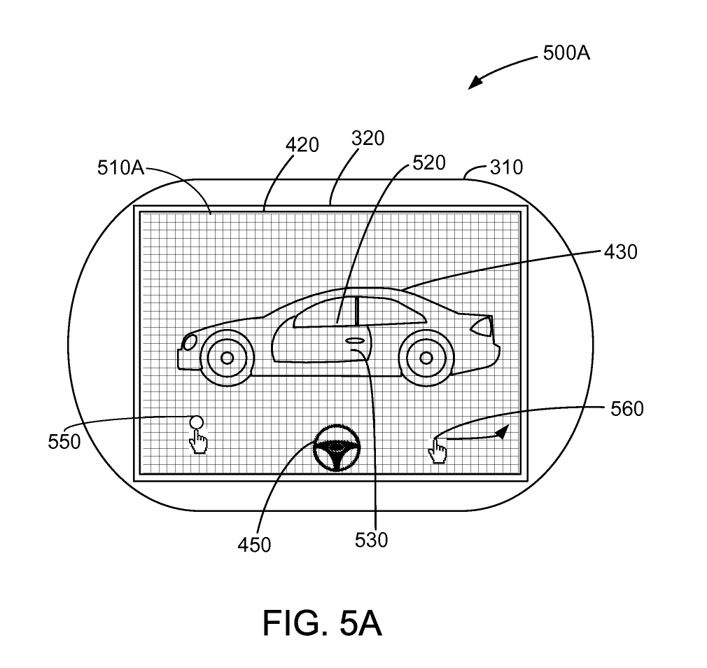

FIG. 5 is example mobile computing device 310 displaying dynamic online content 420 along with an overlay layer, specifically an activation overlay layer 510, using computing device 200 (shown in FIG. 2) in advertising environment 100 (shown in FIG. 1). Example 500 depicts dynamic online content 420 displayed on mobile computing device display 320 of mobile computing device 310. As in FIG. 4, dynamic online content 420 includes online creative elements 430, and user interaction element 450. Activation overlay layer 510 is presented “on top” of dynamic online content. As used herein, “layer” refers to a virtual concept in user interface (“UI”) design. UI design involving layers may display a first graphical or visual element on a display at a different apparent depth than at least a second graphical or visual element. As indicated in example 500, a layer appearing closer to a user (i.e., an “upper” layer) may be displayed “over” a layer appearing removed from a user (i.e., a “lower” layer) wherein the upper layer is entirely viewable by a user while a lower layer may be partially or completely obscured. In some examples, an upper layer may be transparent and therefore invisible to the user but still inhibit or alter interaction with lower layers.

In some cases, the presence of layers may be apparent to a viewer due to a transparency in an upper layer which allows a user to view the upper layer and at least portions of the lower layer. In other cases, the presence of layers may be apparent to a viewer due to an upper layer incompletely covering a lower layer. In such cases, portions of the lower layer which are not covered may be visible to the user. It may be valuable to indicate to a user that layers are present to convey the fact that the user is viewing an activation overlay layer 510.

In other cases, the presence of layers may only be apparent to a viewer at the conclusion of viewing an upper layer. When the upper layer is removed by a user dismissal, timed removal, or other removal, the upper layer may be removed using an animation which indicates that it is being replaced by a lower layer. This animation may appear to indicate that an upper layer is fading out of the screen and exposing a lower layer conveying the concept that the lower layer was always present below the upper layer. Other animations or graphical methods may be used to convey the concept of layers.

In the example embodiment, the upper layer, activation overlay layer 510, is at least partially transparent. A user such as user 154 (shown in FIG. 1) may notice the presence of content including dynamic online content 420 below activation overlay layer 510. Activation overlay layer 510 additionally only occupies a horizontal band over dynamic online content 420, further indicating the presence of dynamic online content 420 below activation overlay layer 510.

When activation overlay layer 510 is first delivered, it fades into the view after a predetermined duration after dynamic online content 420 is delivered. Fading in also may occur for a predetermined duration. In other words, dynamic online content 420 first appears and is “covered” by activation overlay layer 510. Additionally, when overlay layer 510 is removed it fades out and completely reveals the lower layer, dynamic online content 420. In other embodiments, other displays and animations may be used to indicate the presence of layers.

Activation overlay layer 510 includes an activation feature 520. Activation feature 520 is configured to receive haptic input including user 154 touching or gesturing activation feature 520. Providing input such as haptic activation input 530 to activation feature 520 will cause activation overlay layer 510 and dynamic online content 420 to be displayed completely. In the example embodiment, activation feature 520 includes a graphical icon indicating the location to provide haptic activation input 530. The graphical icon further shows user 154 that activation overlay layer 510 is enabled. Making user 154 aware that activation overlay layer 510 is enabled may be important to ensuring user 154 provides an appropriate haptic input. In alternative embodiments, activation feature 520 may include textual elements, graphical elements, video elements, animation elements, or alternately activation feature 520 may not be visibly apparent.

Activation overlay 510 is also configured to receive a haptic ignore input 540. Receiving haptic ignore input 540 from user 154 will cause activation overlay layer 510 and dynamic online content 420 to be removed from display and a requested publication to be delivered.

In operation, activation overlay layer 510 is delivered simultaneously with or shortly after dynamic online content 420. Activation overlay 510 may appear with an animation such as a fade-in. Activation overlay layer 510 may prevent user 154 from interacting with dynamic online content 420 even though user 154 can see portions of dynamic online content due to the partial transparency of overlay layer 510. Therefore, until user 154 enters haptic activation input 530 at activation feature 520, user 154 will not be able to interact with dynamic online content 420. This may be valuable to ensure that user 154 is only interacting with content such as dynamic content 420 intentionally. Alternately, if user 154 does not wish to interact with dynamic online content 420, user 154 may enter haptic ignore input 540 and cause activation overlay layer 510 and dynamic online content 420 to be removed from display and a requested publication to be delivered.

In the example embodiment, when activation overlay layer 510 is displayed, it is apparent that activation overlay layer 510 is present based upon graphical display because activation overlay layer 510 is partially transparent and incompletely covers dynamic online content 420. In other embodiments, activation overlay layer 510 may be made apparent by any method including, without limitation, graphical indications, sonic indications, and haptic indications.

FIG. 5A is example mobile computing device 310 displaying dynamic online content 420 along with an alternative overlay layer, specifically a tap overlay layer 510A, using computing device 200 (shown in FIG. 2) in advertising environment 100 (shown in FIG. 1). As in FIG. 5, dynamic online content 420 includes online creative elements 430, and user interaction element 450. Additionally, as in FIG. 5, dynamic online content 420 is covered tap overlay layer 510A forming an upper layer over dynamic online content 420. However, tap overlay layer 510A is entirely transparent and therefore not visible to a user such as user 154 (shown in FIG. 1). Instead, tap overlay layer 510A is capable of distinguishing between haptic inputs to determine whether to allow user 154 to interact with dynamic online content 420 or to advance to a requested publication.

Tap overlay layer 510A is configured to receive haptic activation input 550 and haptic ignore input 560. Like haptic ignore input 540 (shown in FIG. 5), providing haptic ignore input 560 will cause tap overlay layer 510A and dynamic online content 420 to be removed and cause mobile computing device 310 to display a publication requested by user 154. In the example embodiment, haptic ignore input 560 is triggered when user 154 provides haptic input including a swipe. In other embodiments, haptic ignore input 560 may be any haptic input or combination of haptic inputs which may be received by mobile computing device display 320.

Tap overlay layer 510A also includes haptic activation input 550. Haptic activation input 550 is configured to receive haptic input including user 154 taps. Like haptic activation input 530 (shown in FIG. 5), providing haptic activation input 550 will cause tap overlay layer 510A to be removed and cause dynamic online content 420 to be displayed completely allowing user 154 to interact with dynamic online content. Additionally, providing haptic activation input 550 will cause tap overlay layer 510A to “pass” haptic input to dynamic online content 420. Therefore, if haptic activation input 550 includes haptic input which would otherwise cause interaction with dynamic online content 420 (e.g., touching the location of user interaction element 450), such haptic input will be received by dynamic online content 420 and cause an interaction.

In the example embodiment, haptic activation input 550 includes user 154 providing haptic input including a haptic tap. In other embodiments, haptic activation input 550 may be any haptic input or combination of haptic inputs which may be received by mobile computing device display 320.

In the example embodiment, tap overlay layer 510A is unaccompanied by text or graphical indications. This may be of use if user 154 is familiar with a standard method of interacting with interface layer 510A. In alternative embodiments, tap overlay layer 510A may be accompanied by indications including text and graphics.

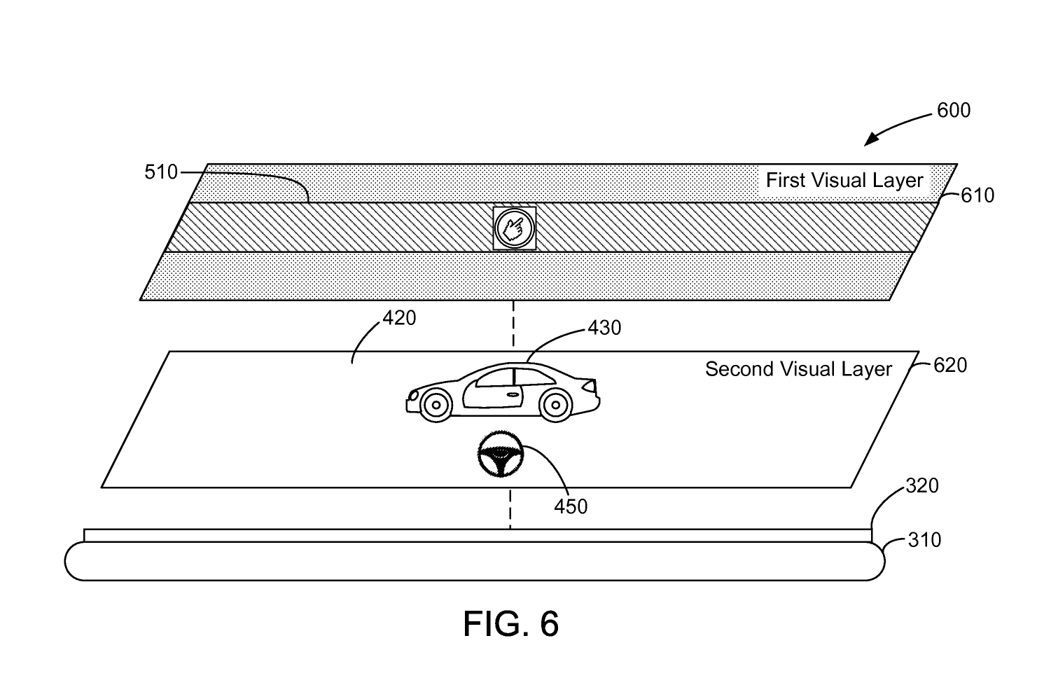

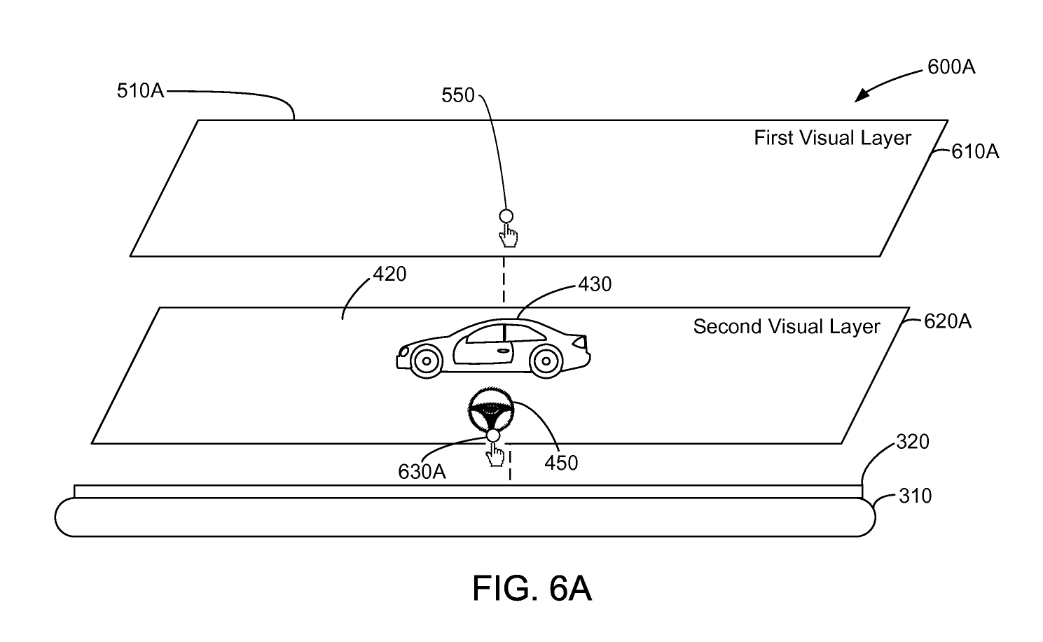

FIG. 6 is a lateral view of example mobile computing device 310 displaying dynamic online content 420 with an overlay layer, specifically activation overlay layer 510, using computing device 200 (shown in FIG. 2) in advertising environment 100 (shown in FIG. 1). As indicated in view 600, activation overlay layer 510 is displayed on first visual layer 610 which is displayed “above” second visual layer 620. Second visual layer 620 includes dynamic online content 420, online creative elements 430, and user interaction element 450. Accordingly, all haptic input received from a user such as user 154 (shown in FIG. 1) viewing the content of view 600 will be received by first visual layer 610 and therefore by activation overlay layer 510.

FIG. 6A is a lateral view of example mobile computing device 310 displaying dynamic online content 420 with an overlay layer, specifically tap overlay layer 510A, using computing device 200 (shown in FIG. 2) in advertising environment 100 (shown in FIG. 1). As indicated in view 600A, tap overlay layer 510A is displayed on first visual layer 610A which is displayed “above” second visual layer 620A. Second visual layer 620A includes dynamic online content 420, online creative elements 430, and user interaction element 450. Accordingly, all haptic input received from a user such as user 154 (shown in FIG. 1) viewing the content of view 600A will be received by first visual layer 610A and therefore by tap overlay layer 510A.

Unlike view 600, some haptic input received by first visual layer 610A will be “passed” down to second visual layer 620A and therefore to dynamic online content 420. In the example embodiment, user 154 provides a haptic tap, haptic activation input 550, to first overlay layer 610A. Haptic activation input 550 is a haptic tap which corresponds to the location of user interaction element 450. Tap overlay layer 510A will receive haptic activation input 550 and cause dynamic online content 420, located on second visual layer 620A, to receive passed haptic input 630A.

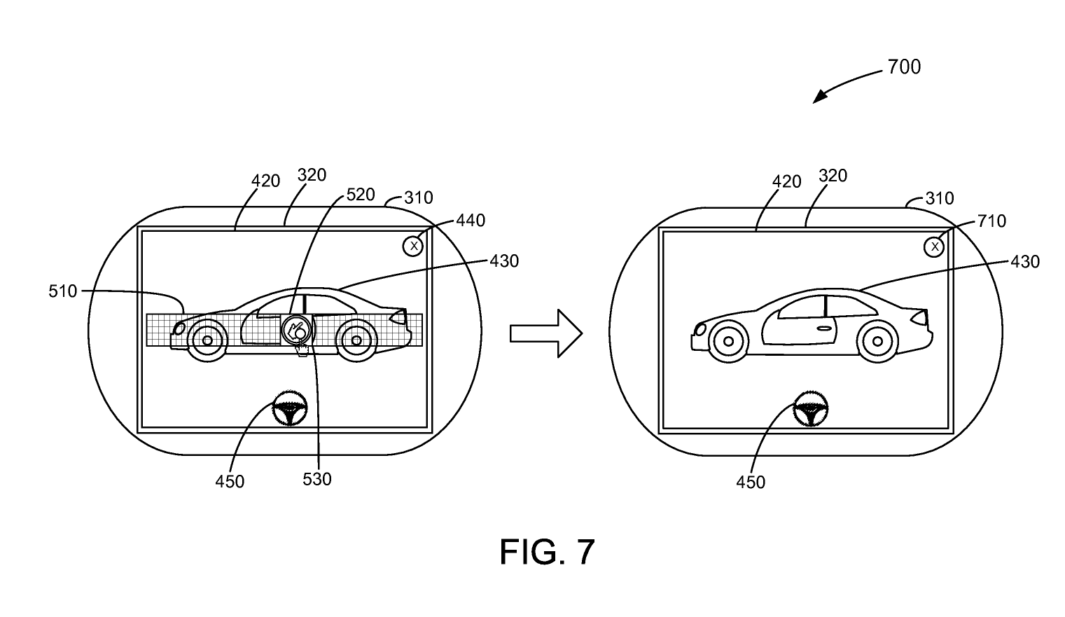

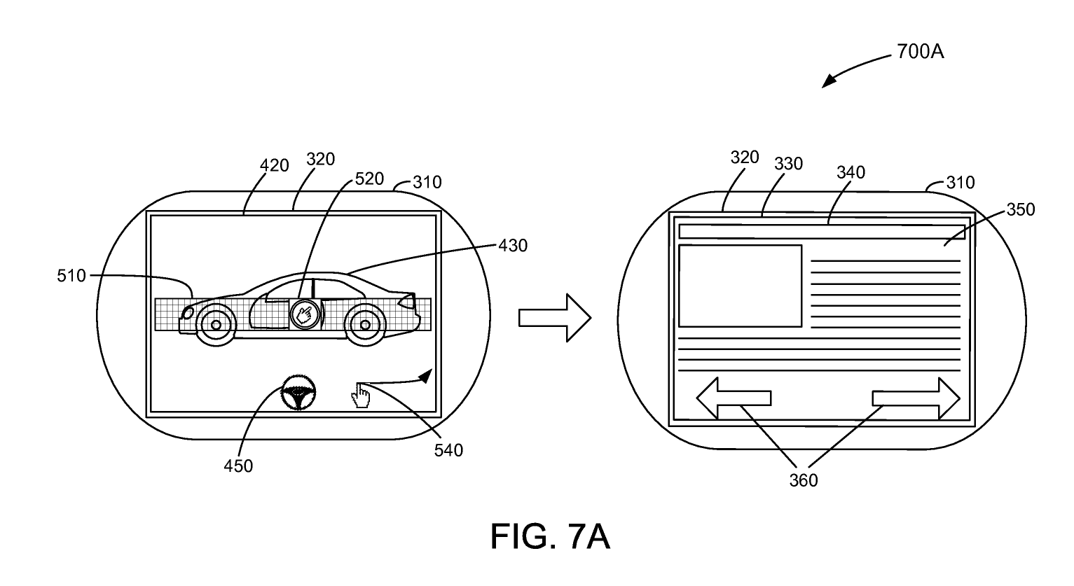

FIG. 7 is a further example mobile computing device 310 displaying dynamic online content 420 with an overlay layer, such as activation overlay layer 510, wherein a user elects to interact with dynamic online content 420, using computing device 200 (shown in FIG. 2) in advertising environment 100 (shown in FIG. 1). A user such as user 154 (shown in FIG. 1) may provide haptic input such as haptic activation input 530 which causes activation overlay layer 510 to be removed. In the example embodiment, activation overlay layer 510 fades out for a predetermined time after user 154 provides haptic activation input 530.

In operation, mobile computing device 310 initially displays, on mobile computing device display 320, dynamic online content 420 including creative online elements 430 and user interaction elements 450. As dynamic online content 420 is displayed, or shortly thereafter, activation overlay layer 510 fades in. Activation overlay layer includes activation feature 520, indicating to user 154 where to provide haptic activation input 530. User 154 provides haptic activation input 530, causing activation overlay layer 510 to be removed. Activation overlay layer 510 is removed in a fade-out animation.

Once activation overlay layer 510 fades out, dynamic online content 420 is visible and available for user interaction. Mobile computing device 310 displays, on mobile computing device 320, dynamic online content 420 including creative online elements 430 and user interaction elements 450. Additionally, dismiss feature 710 is displayed. Dismiss feature 710 allows user 154 to provide input (e.g, haptic input) to indicate that user 154 does not want to see dynamic online content 420. In the example embodiment, if user 154 taps dismiss feature 710, dynamic online content 420 will be removed from display on mobile application 330. In the example embodiment, the graphical indicator of activation feature 520 animates to the top right portion of the screen and changes to become dismiss feature 710. In other embodiments, dismiss feature 710 may appear through other methods and may appear with a different visual appearance.

FIG. 7A is a further illustration of example mobile computing device 310 displaying dynamic online content 420 with an overlay layer, such as activation overlay layer 510, wherein a user elects to interact dismiss dynamic online content 420 and navigate to requested publication item including online publication content 350, using computing device 200 (shown in FIG. 2) in advertising environment 100 (shown in FIG. 1). A user such as user 154 (shown in FIG. 1) may provide haptic input such as haptic ignore input 540 which causes activation overlay layer 510 to be removed along with dynamic online content 420. In the example embodiment, activation overlay layer 510 slides off-screen along with dynamic online content 420 after user 154 provides haptic ignore input 540.

In operation, mobile computing device 310 initially displays, on mobile computing device display 320, dynamic online content 420 including creative online elements 430 and user interaction elements 450. As dynamic online content 420 is displayed, or shortly thereafter, activation overlay layer 510 fades in. Activation overlay layer includes activation feature 520, indicating to user 154 where to provide haptic activation input 530. User 154 provides haptic ignore input 540, causing activation overlay layer 510 and dynamic online content 420 to be removed. Activation overlay layer 510 and dynamic online content are removed in an animation where both slide to the right, off-screen.

Once activation overlay layer 510 fades out, mobile application 330 is visible. Mobile computing device 310 displays, on mobile computing device 320, mobile application 330 including online publication resource 340, online publication content 350, and navigation elements 360.

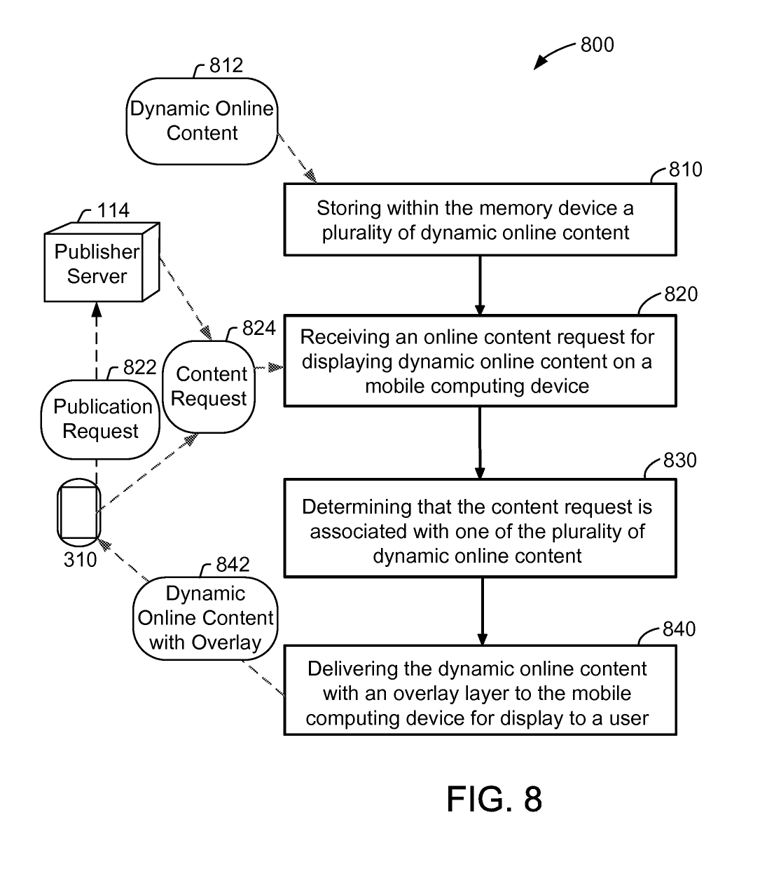

FIG. 8 is an example method 800 for serving dynamic online content 420 (shown in FIG. 4) along with an overlay layer such as activation overlay layer 510 or tap overlay layer 510A (shown in FIG. 5) on a mobile computing device 310 using advertising environment 100 (shown in FIG. 1). Method 800 is implemented by an online content server such as ad serving system 120 (shown in FIG. 1). Ad serving system 120 is a computing device illustrated by computing device 200 (shown in FIG. 2) and accordingly includes a memory device, main memory 206, and a processor 204 (shown in FIG. 2). Ad serving system 120 stores 810 within memory device 206 a plurality of dynamic online content 812. In the example embodiment, dynamic online content 812 includes advertisements such as dynamic online content 420 (shown in FIG. 4). In alternative embodiments, dynamic online content 812 may be, without limitation, an online advertisement, text, animation, video, or any other content which may be served and displayed using mobile application 330 (shown in FIG. 3). Storing 810 represents ad serving system 120 writing dynamic online content 812 to memory.

Ad serving system 120 receives 820 a content request 824 for displaying online content on a mobile computing device. Content request 824 is initiated at least in part by a publication request 822 submitted by mobile computing device 310. In other words, mobile computing device 310 makes an publication request 822 for content such as a web periodical which causes the creation of an content request 824. Content request 824 may be sent from publisher server 114 which received publication request 822. Alternately, content request 824 may be sent from mobile computing device 310 after mobile computing device 310 delivers publication request 822 to publisher server 114. Content request 824 may additionally indicate that the publisher wishes dynamic online content to be presented with an activation overlay 510 (shown in FIG. 5), a tap overlay 510A (shown in FIG. 5A), or no overlay.

Ad serving system 120 determines 830 that content request 824 is associated with one of the plurality of dynamic online content. Determining 830 that content request 824 is associated with one of the plurality of dynamic online content represents determining that content request 824 is associated with plurality of dynamic online content 812 stored in memory device 206. Ad serving system 120 may determine 830 based upon the fact that content request 824 initiated from mobile computing device 310. As described above, mobile computing device 310 particularly benefits from dynamic online content 812 as described herein. Alternately ad serving system 120 may determine 830 based upon the fact that content request 824 is associated with a particular publication request 822.

Ad serving system 120 then delivers 840 dynamic online content 842 with an overlay layer to mobile computing device 310 for displaying to the user. Delivering 840 represents serving dynamic online content with overlay 842, selected from plurality of dynamic online content 812, to mobile computing device 310. Delivering 840 further represents determining whether to provide activation overlay 510, tap overlay 510A with dynamic online content 420 or no overlay. As discussed above, publisher server 114 may submit a request for a particular overlay or no overlay in conjunction with content request 824.

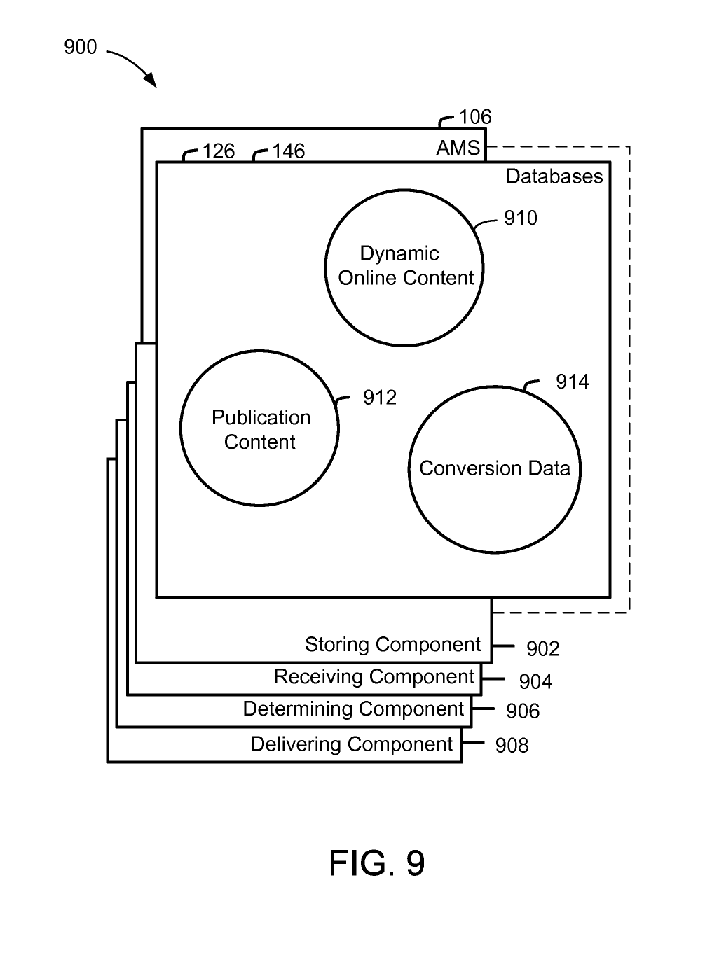

FIG. 9 is a diagram 900 of components of one or more example computing devices, for example computing device 200 (shown in FIG. 2), that may be used in the environment shown in FIG. 1. For example, one or more of computing devices 200 may form advertising management system (AMS) 106 or mobile computing device 310. FIG. 9 further shows a configuration of databases 126 and 146 (shown in FIG. 1). Databases 126 and 146 are coupled to several separate components within AMS 106 and/or mobile computing device 310, which perform specific tasks.

AMS 106 includes a storing component 902 for storing a plurality of dynamic online content associated with the display of dynamic online content 420 (shown in FIG. 4) on mobile computing device 310. AMS 106 also includes a receiving component 904 for receiving a content request for displaying dynamic online content on a mobile computing device 310. The content request is initiated at least in part by a publication request submitted by mobile computing device 310 for displaying a first publication item on the mobile computing device 310. AMS 106 additionally includes a determining component 906 for determining that the content request is associated with one of the plurality of dynamic online content. AMS 106 additionally includes a delivering component 908 for delivering the dynamic online content with an overlay layer to mobile computing device 310 for display to a user. The overlay layer is positioned at least partially over the dynamic online content on mobile computing device 310. The overlay layer allows the user to provide haptic input to activate the dynamic online content or navigate to a navigated publication item representing one of the first publication item or a second publication item.

In an exemplary embodiment, databases 126 and 146 are divided into a plurality of sections, including but not limited to, a dynamic online content section 910, a publication item section 912, and a conversion data section 914. These sections within database 126 and 146 are interconnected to update and retrieve the information as required. Dynamic online content section 910 may include information including, for example, dynamic online content, tap overlay layers, activation overlay layers, haptic inputs associated with tap overlay layers, haptic inputs associated with activation overlay layers, graphics and text associated with dismiss functions, and overlay layer characteristics. Publication content section 912 may include information including, for example, identifiers for publication content which will be served with dynamic online content, identifiers for publication content which will be served without dynamic online content, and information regarding how to deliver dynamic online content with specific publication content. Conversion data section 914 may include information including, for example, display time associated with particular dynamic online content, user interaction with dynamic online content, and dismiss function records associated with dynamic online content.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included.

Also, the particular naming of the components, capitalization of terms, the attributes, data structures, or any other programming or structural aspect is not mandatory or significant, and the mechanisms that implement the subject matter described herein or its features may have different names, formats, or protocols. Further, the system may be implemented via a combination of hardware and software, as described, or entirely in hardware elements. Also, the particular division of functionality between the various system components described herein is merely for the purposes of example only, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

While the disclosure has been described in terms of various specific embodiments, it will be recognized that the disclosure can be practiced with modification within the spirit and scope of the claims.

What is claimed is:

1. A computer-implemented method for serving dynamic online content having a publication item on a mobile computing device, the method implemented using an online content server coupled to a memory device, the method comprising:
storing within the memory device a plurality of dynamic online content;
receiving, at the online content server, a content request for displaying dynamic online content on a mobile computing device, wherein the content request is initiated at least in part by a publication request being submitted by the mobile computing device for displaying a first publication item on the mobile computing device;
determining, at the online content server, that the content request is associated with one of the plurality of dynamic online content; and
delivering the dynamic online content with an overlay layer to the mobile computing device for display to a user,
wherein the overlay layer is positioned at least partially over the dynamic online content on the mobile computing device, and
wherein the overlay layer allows the user to provide haptic input to:
activate the dynamic online content; or
navigate to a navigated publication item representing one of the first publication item or a second publication item.

2. The method of claim 1, wherein storing a plurality of dynamic online content further comprises storing a plurality of dynamic online advertisements.

3. The method of claim 1, wherein delivering the dynamic online content with an overlay layer to the mobile computing device for display to a user further comprises delivering a tap overlay layer wherein the tap overlay layer allows user-initiated haptic taps to interact with the dynamic online content and user-initiated haptic swipes to navigate to the navigated publication item.

4. The method of claim 1, wherein delivering the dynamic online content with an overlay layer to the mobile computing device for display to a user further comprises delivering an activation overlay layer wherein the activation overlay layer requires a user-initiated haptic tap on at least one portion of the activation overlay layer for the user to interact with the dynamic online content.

5. The method of claim 1, wherein delivering the dynamic online content further comprises delivering a user indication that dynamic online content is being delivered wherein the user indication is at least one of:
a graphical indication;
a sonic indication; and
a haptic indication.

6. The method of claim 1 wherein determining that the content request is associated with one of the plurality of dynamic online content further comprises determining that the dynamic online content should be served without an overlay layer based upon a request by a publisher of the first publication item.

7. The method of claim 1, wherein delivering the dynamic online content with an overlay layer to the mobile computing device for display to a user further comprises delivering an activation indicator displayed to the user indicating whether the overlay layer is enabled or disabled.

8. An online content server for serving dynamic online content along with a publication item on a mobile computing device, the online content server comprising a memory device for storing data, and a processor in communication with the memory device, said processor programmed to:
store within the memory device a plurality of dynamic online content;
receive a content request for displaying dynamic online content on a mobile computing device, wherein the content request is initiated at least in part by a publication request being submitted by the mobile computing device for displaying a first publication item on the mobile computing device;
determine that the content request is associated with one of the plurality of dynamic online content; and
deliver the dynamic online content with an overlay layer to the mobile computing device for display to a user,
wherein the overlay layer is positioned at least partially over the dynamic online content on the mobile computing device, and
wherein the overlay layer allows the user to provide haptic input to:
activate the dynamic online content; or
navigate to a navigated publication item representing one of the first publication item or a second publication item.

9. The online content server of claim 8, wherein the processor programmed to store a plurality of dynamic online content is further programmed to store a plurality of dynamic online advertisements.

10. The online content server of claim 8, wherein the processor is further programmed to deliver a tap overlay layer wherein the tap overlay layer allows user-initiated haptic taps to interact with the dynamic online advertisements and user-initiated haptic swipes to navigate to the navigated publication item.

11. The online content server of claim 8, wherein the processor is further programmed to deliver an activation overlay layer wherein the activation overlay layer requires a user-initiated haptic tap on at least one portion of the activation overlay layer for the user to interact with the dynamic online advertisements.

12. The online content server of claim 8, wherein the processor is further programmed to deliver the dynamic online content with a user indication to the user that dynamic online content is being delivered, wherein the user indication is at least one of:
a graphical indication;
a sonic indication; and
a haptic indication.

13. The online content server of claim 8 wherein the processor is further programmed to determine that the dynamic online content should be served without an overlay layer based upon a request by a publisher of the first publication item.

14. The online content server of claim 8, wherein the processor is further programmed to deliver an activation indicator displayed to the user indicating whether the overlay layer is enabled or disabled.

15. A computer-readable storage device, having processor-executable instructions embodied thereon, for serving dynamic online content in combination with a publication item on a mobile computing device, wherein the computing device includes at least one processor and a memory device coupled to the processor, wherein, when executed by the computing device, the processor-executable instructions cause the computing device to:
store within the memory device a plurality of dynamic online content;
receive a content request for displaying dynamic online content on a mobile computing device, wherein the content request is initiated at least in part by a publication request being submitted by the mobile computing device for displaying a first publication item on the mobile computing device;
determine that the content request is associated with one of the plurality of dynamic online content; and
deliver the dynamic online content with an overlay layer to the mobile computing device for display to a user,
wherein the overlay layer is positioned at least partially over the dynamic online content on the mobile computing device, and
wherein the overlay layer allows the user to provide haptic input to:
activate the dynamic online content; or
navigate to a navigated publication item representing one of the first publication item or a second publication item.

16. The computer-readable storage device of claim 15, wherein the processor-executable instructions cause the computing device to store a plurality of dynamic online advertisements.

17. The computer-readable storage device of claim 15, wherein the processor-executable instructions cause the computing device to deliver a tap overlay layer wherein the tap overlay layer allows user-initiated haptic taps to interact with the dynamic online advertisements and user-initiated haptic swipes to navigate to the navigated publication item.

18. The computer-readable storage device of claim 15, wherein the processor-executable instructions cause the computing device to deliver an activation overlay layer wherein the activation overlay layer requires a user-initiated haptic tap on at least one portion of the activation overlay layer for the user to interact with the dynamic online advertisements.

19. The computer-readable storage device of claim 15, wherein the processor-executable instructions cause the computing device to deliver the dynamic online content with a user indication to the user that one of the plurality of dynamic online content is being delivered, wherein the user indication is at least one of:
a graphical indication;
a sonic indication; and
a haptic indication.

20. The computer-readable storage device of claim 15, wherein the processor-executable instructions cause the computing device to determine that the dynamic online content should be served without an overlay layer based upon a request by a publisher of the first publication item.

21. The computer-readable storage device of claim 15, wherein the processor-executable instructions cause the computing device to deliver an activation indicator displayed to the user indicating whether the overlay layer is enabled or disabled.
